(19) United States
(12) Patent Application Publication
(10) Pub. No.: US 2006/0265198 A1
(43) Pub. Date: Nov. 23, 2006

(54) Apparatus and a method of feature edge extraction from a triangular mesh model

(76) Inventors: Satoshi Kanai, Sapporo-shi (JP); Takeshi Kishinami, Sapporo-shi (JP); Tomohiro Mizoguchi, Sapporo-shi (JP); Hiroaki Date, Sapporo-shi (JP)

Correspondence Address: JOHN S. PRATT, ESQ;KILPATRICK STOCKTON, LLP, 1100 PEACHTREE STREET, ATLANTA, GA, 30309, US

(21) Appl. No.: 11/218,059

(22) Filed: Aug. 31, 2005

(30) Foreign Application Priority Data
Mar. 1, 2005 (JP) 2005-056188

(51) Int. Cl. G06F 17/10

(52) U.S. Cl. 703/2

(57) ABSTRACT

A feature edge extraction technique supports automatic creation of a solid model from a 3D or triangular mesh model. The technique extracts feature edges from the 3D mesh model according to a global normal-line evaluation method and an improved watershed method. The technique uses data related to the 3D mesh model, defines an area with a Euclidean distance, globally evaluates normals of triangles in the area, calculates edge and vertex feature values, carries out discretization and differentiation on the calculated vertex feature values, extracts feature edges satisfying requirements, divides the mesh model into segments each consisting of connected triangles according to the improved watershed method that is capable of grouping vertexes, extracts the boundaries of each segment as feature edges, allows a user to interactively select required feature edges from among the extracted feature edges, and outputs data related to the selected feature edges.

### CROSS-REFERENCE TO RELATED APPLICATION

This application is based upon and claims the benefit of priority from the prior Japanese Patent Application No. 2005-056188, filed on Mar. 1, 2005. The entire contents of which are incorporated herein by reference.

### BACKGROUND OF THE INVENTION

1. Field of the Invention

The present invention relates to a method of and an apparatus for extracting feature edges from a triangular or three-dimensional mesh model and automatically generating a solid model.

2. Background Art

Three-dimensional (3D) measuring devices used in reverse engineering have improved their performance in recent years and now are capable of preparing high-density mesh models from physical models. The mesh models are stored in a 3D database and are retrieved therefrom to reuse them when developing and designing new products.

When developing an industrial product, the product must be precisely designed and a solid model of the product must be prepared. Preparing a solid model from a 3D or triangular mesh model takes a long time according to the present technology. To shorten a product developing time, what is needed is a technique of automatically generating a solid model from a mesh model. In the field of reverse engineering, studies for generating solid models from 3D mesh models are energetically carried out. It is presently difficult, however, to automatically generate a solid model from a mesh model having a complicated shape.

One approach for automatically generating a solid model from a mesh model is to properly extract feature edges from the mesh model and conduct surface fitting according to the feature edges (P. Benko, R. R. Martin, and T. Varady, “Algorithms for reverse engineering boundary representation models,” Computer-Aided Design 33 (11), 839-851, 2001). The feature edges mentioned here are the boundaries of a region that is composed of connected polygons (triangles when using triangular meshes) and is to be recognized as a single functional segment. When extracting such feature edges, there are four requirements.

The first requirement is to extract feature edges with a minimum influence of noise or mesh forming methods. The second requirement is to correctly extract, as feature edges, the boundaries of each fillet surface (a rounded surface that connects two surfaces to each other) frequently contained in industrial products. The third requirement is to extract feature edges that form a loop so that a region surrounded with the loop is recognized as a single segment. The fourth requirement is to allow a user to selectively extract feature edges depending on a purpose of use. There is presently no feature edge extraction technique that completely satisfies these four requirements.

There are two major methods for extracting feature edges from a mesh model. One is to directly extract feature edges from a mesh model, and the other is to divide a mesh model into segments and extract the boundaries of the segments as feature edges.

The former method of directly extracting feature edges from a mesh model is disclosed in Daichl Watanabe and Hiroaki Chiyokura, “Feature edge extraction from arbitrary triangular meshes,” The Institute of Electronics, Information and Communication Engineers Transactions, D-IIJ83-D-II (5), 1344-1352, 2000; A. Meyer and P. Marin, “Segmentation of 3D triangulated data points using edges constructed with a C1 discontinuous surface fitting,” Computer-Aided Design 36, 1327-1336, 2004; and Yutaka Ohtake, Alexander Belyaev, and Hans-Peter Seidel, “Ridge-Valley Lines on Meshes via Implicit Surface Fitting,” ACM Transactions on Graphics 23 (3), 652-663, 2004. The method disclosed in the document of Watanabe, et al. simplifies a triangular mesh model by storing shape feature edges as many as possible. To achieve this, the method calculates edge feature values according to the edge connectivity and dihedral angle of each edge and the curvature of a partial region defined by a phase distance related to the edge, groups edges having feature values exceeding a threshold value specified by a user, and extracts the grouped edges as feature edges. This method defines a region with a phase distance, evaluates a group of edges in the region, and calculates edge feature values. Due to this, the method has a problem that feature edges to be extracted are dependent on a method used to form the mesh model. The method has another problem that extracted feature edges do not loop because the feature edges are extracted with the use of a threshold value.

The method disclosed in the document of Meyer, et al. evaluates dihedral angles of meshes to find a start point, fits to the start point an “absoid” surface that can properly express a local discontinuous shape, finds an original edge start point, and generates feature edges. The generated feature edges are connected to each other at their end points. This method has a problem that, if an objective mesh model is composed of a small number of triangles, feature edges to be extracted sometimes do not loop.

The method disclosed in the document of Ohtake, et al. calculates curvatures on approximate implicit function surfaces generated from an input mesh model, detects feature edges according to the curvatures, and projects the detected feature edges on the original mesh model to thereby extract feature edges. This method approximates and generates implicit function surfaces from an input mesh model, and on the implicit function surfaces, calculates higher-order differential values that are not obtainable directly from the mesh model. According to the higher-order differential values, the method extracts ridges and valleys of the mesh model. This method has a problem that the extracted feature edges do not loop. A loop is formed only through intricate postprocesses. The method has another problem that feature edges to be extracted are dependent on the orientation of a mesh model and a long time is needed to calculate higher-order differential values on implicit function surfaces.

The latter method of extracting feature edges from divided regions is disclosed in A. P. Mangan and R. T. Whitaker, “Partitioning 3D Surface Meshes Using Watershed Segmentation,” IEEE Transactions on visualization and computer graphics 5 (4). 308-321, 1999; Y. Sun, D. L. Page, J. K. Paik, A. Koschan, and M. A. Abidi, “Triangle mesh-based edge detection and its application to surface segmentation and adaptive surface smoothing,” Proc. IEEE ICIP 2002, 825-828, 2002; and Y. Sun, “Surface Modeling and Analysis Using Range Images, Smoothing, Registration, Integration and Segmentation,” A Dissertation Presented for the Doctor of Philosophy Degree, The University of Tennessee, Knoxville, 2002. These documents relate to a technique of separating a triangular mesh model that is obtained by reverse engineering and contains much noise. The technique calculates a feature value for each vertex, carries out segmentation based on the calculated feature values with the use of the watershed method, and extracts the boundaries of each segment as feature edges. The feature edges extracted with the use of the watershed method are greatly dependent on the vertex feature values. To extract feature edges with a minimum influence of measurement noise contained in a mesh model or a method used to form the mesh model, it is necessary to globally, instead of locally, evaluate the mesh model when calculating vertex feature values. The watershed method, however, separates a mesh model into segments each containing vertexes, and at this time, creates a gap between adjacent segments. The gap contains triangles belonging to no segments, thereby forming a feature edge that must be shared as a boundary between adjacent segments but is actually shared by no segments.

There is another document by S. Pulla, A. Razdan, and Gerald Farin, “Improved Curvature Estimation for Watershed Segmentation of 3-Dimensional Meshes,” Arizona State University, Technical Report, 2001. To calculate feature values, this method generates an approximate Bezier surface around each vertex of an input mesh model, calculates an approximate curvature of the Bezier surface, and provides the calculated approximate curvature as a vertex feature value. By expanding a range for which an approximate Bezier surface is generated, the method may reduce the influence of noise contained in the input mesh model. This method, however, has a problem that the feature value involves a large error if the vertex is on sharp edges. The method has another problem that calculated feature values are dependent on approximation accuracy and increasing the approximation accuracy extends a calculation time.

A. Razdan and M. S. Bae disclose another technique in “A hybrid approach to feature segmentation of triangle meshes,” Computer-Aided Design 35, 783-789, 2003. This technique is based on the watershed method and is capable of properly dividing a mesh model into segments even if the mesh model includes a surface region that must be recognized as a single segment but contains no vertex, such as a rectangular region composed of two triangles. Surface regions containing no vertex are unable to properly separate with the watershed method and are frequently observed in triangular mesh models formed by tessellation of solid models or parametric surface models. The technique of Razdan, et al. calculates vertex feature values according to a method described in the document of Pulla, et al. According to Razdan, et al., every triangle belongs to a segment, and therefore, no gap is created between adjacent segments. As a result, each extracted feature edge is shared between adjacent segments.

M. Vieira and K. Shimada disclose another technique in “Segmentation of Noisy Laser-Scanner Generated Meshes with Piecewise Polynomial Approximations,” Proceedings of DETC '04, 2004. This technique generates an approximate biquadratic surface, approximates the curvature of each vertex according to the approximate surface, carries out smoothing on the curvature, and provides a feature value that is little affected by noise. This technique forms a seed region with the use of the curvature and expands the seed region to create a segment containing vertexes. This technique, however, produces a gap between adjacent segments. The gap contains triangles that belong to no segments. The gap results in creating a feature edge that must be shared as a boundary between adjacent segments but is actually shared by no segments. This technique also creates a segment containing a small number of vertexes. The boundaries of such a segment are extracted as minute feature edges that are useless.

Another feature edge extracting method is disclosed in S. Katz and A. Tal, “Hierarchical mesh decomposition using fuzzy clustering and outs,” ACM Transactions on Graphics 22 (3), 954-961, 2003. This method is a hierarchical method that avoids excessive segmentation and extracts smooth boundaries. The method employs a maximum flow rate algorithm to solve cuts of a dual graph of meshes and carries out segmentation. The method is unable to conduct region-by-region segmentation that is needed for industrial products and takes a long segmentation processing time.

A common problem of the above-mentioned techniques and methods is that none of them is capable of properly extracting the boundaries of a fillet surface as feature edges. Another common problem is that a single set of extraction parameters used to define, for example, a mesh evaluation range is insufficient to correctly calculate feature values and extract required feature edges.

### SUMMARY OF THE INVENTION

An object of the present invention is to provide a technique of extracting feature edges from a 3D or triangular mesh model based on a global normal-line evaluation and an improved watershed method, supporting automatic generation of a solid model from the mesh model, and satisfying the above-mentioned four requirements.

In order to accomplish the object, a first aspect of the present invention provides an apparatus for extracting feature edges from a triangular mesh model. The apparatus includes a storage unit configured to store data, a vertex feature value calculator configured to retrieve data related to the mesh model from the storage unit, globally evaluate normals of triangles in each region that is defined on the mesh model by a Euclidean distance, calculate edge and vertex feature values based on a result of the evaluation, carry out discretization and differentiation on the calculated vertex feature values, and extract feature edges; a segmentation unit configured to separate the mesh model into segments each composed of a set of connected triangles according to the calculated feature values and an improved watershed method capable of grouping vertexes and extract boundaries of the segments as feature edges; and a feature edge selective extractor configured to allow a user to interactively select required feature edges from among the extracted feature edges and output data related to the selected feature edges.

A second aspect of the present invention provides a program for extracting feature edges from a triangular mesh model. The program instructs a computer to execute the steps of retrieving data related to the mesh model from an input unit or a storage unit; globally evaluating normals of triangles in each region that is defined on the mesh model by a Euclidean distance, calculating edge and vertex feature values, carrying out discretization and differentiation on the calculated vertex feature values, and extracting feature edges; separating the mesh model into segments each composed of a set of connected triangles according to the calculated vertex feature values and an improved watershed method capable of grouping vertexes, and extracting boundaries of the segments as feature edges; and allowing a user to interactively select required feature edges from among the extracted feature edges and outputting data related to the selected feature edges.

The program for extracting feature edges from a triangular mesh model may further include the steps of setting extraction parameters and the number of times of repetition; and repeating the steps with the use of the set extraction parameters for the set number of times of repetition.

A third aspect of the present invention provides a method of extracting feature edges from a triangular mesh model. The method includes the steps of retrieving data related to the mesh model from an input unit or a storage unit; globally evaluating normals of triangles in each region that is defined on the mesh model by a Euclidean distance, calculating edge and vertex feature values, carrying out disoretization and differentiation on the calculated vertex feature values, and extracting feature edges; separating the mesh model into segments each composed of a set of connected triangles according to the calculated vertex feature values and an improved watershed method capable of grouping vertexes, and extracting boundaries of the segments as feature edges; and allowing a user to interactively select required feature edges from among the extracted feature edges and outputting data related to the selected feature edges.

The method of extracting feature edges from a triangular mesh model may further include the steps of setting extraction parameters and the number of times of repetition; and repeating the steps with the use of the set extraction parameters for the set number of times of repetition.

The technique according to the present invention of extracting feature edges from a 3D or triangular mesh model is capable of extracting feature edges with a minimum influence of measurement noise contained in the mesh model or a method used to form the mesh model. The technique is capable of recognizing an area surrounded with feature edges as a single segment and extracting the boundaries of a fillet surface as feature edges that are hardly extractable with the related arts. The technique of the present invention may set different extraction parameters to extract feature edges from which a user may select required feature edges. The selected feature edges are aggregated and may be read into a 3D CAD system.

### BRIEF DESCRIPTION OF THE DRAWINGS

FIG. 1 is a block diagram showing an apparatus for extracting feature edges from a 3D mesh model according to an embodiment of the present invention;

FIG. 2 is a flowchart showing a program or method of extracting feature edges from a 3D mesh model according to an embodiment of the present invention executed with the apparatus of FIG. 1;

FIG. 3 is an explanatory view showing an edge feature calculating process according to an embodiment of the present invention executed with the apparatus of FIG. 1;

FIG. 4A is a graph showing continuous vertex feature values extracted with the apparatus of FIG. 1;

FIG. 4B is a graph showing discrete vertex feature values extracted with the apparatus of FIG. 1;

FIG. 4C is a graph showing differential vertex feature values extracted with the apparatus of FIG. 1;

FIG. 5A is a view showing feature edges formed from the continuous vertex feature values of FIG. 4A,

FIG. 5B is a view showing feature edges formed from the discrete vertex feature values of FIG. 4B;

FIG. 5C is a view showing feature edges formed from the differential vertex feature values of FIG. 4C;

FIG. 6 is a flowchart showing the watershed method;

FIG. 7A is a perspective view showing a model to be processed with the watershed method;

FIG. 7B is a sectional view showing the model of FIG. 7A;

FIG. 7C is a diagram developed from the model of FIG. 7A using the heights thereof as feature values;

FIG. 7D is a diagram showing labels attached to vertexes of the diagram of FIG. 7C:

FIG. 7E is a diagram showing vertexes grouped according to the labels;

FIG. 7F is a first diagram prepared by removing small segments; FIG. 7G is a second diagram prepared by removing small segments;

FIG. 7H is a diagram showing an unsatisfactory result of segmentation according to the watershed method;

FIG. 8 is a flowchart showing an improved watershed method executed with the apparatus of FIG. 1;

FIG. 9A is a perspective view showing a mesh model to be processed with the improved watershed method, each segment to be recognized containing no vertex:

FIGS. 9B to 9G are diagrams developed from a sectional view of FIG. 9A using the heights thereof as feature values;

FIG. 10 is an explanatory view showing vertex adding rules executed with the apparatus of FIG. 1;

FIG. 11 is a table showing the details of the vertex adding rules;

FIG. 12A is a first view showing a result of feature edge extraction according to the conventional watershed method;

FIG. 12B is a second view showing a result of feature edge extraction according to the conventional watershed method;

FIG. 12C is a first view showing a result of feature edge extraction according to the improved watershed method;

FIG. 12D is a second view showing a result of feature edge extraction according to the improved watershed method:

FIG. 13A is a view showing a result of a selective feature edge extraction executed with the apparatus of FIG. 1 in which a top face is selected;

FIG. 13B is a vies showing a result of a selective feature edge extraction executed with the apparatus of FIG. 1 in which a side of a top face is selected;

FIG. 14A is a photograph showing a mock-up of an IT hardware casing made of hard urethane foam, the mock-up being an object from which the apparatus of FIG. 1 extracts feature edges;

FIG. 14B is a high-density mesh model formed from points measured on the mock-up;

FIG. 14C is a view showing a result of segmentation carried out with a set of extraction parameters

FIG. 14D is a view showing feature edges extracted from the boundaries of the segments of FIG. 14C;

FIG. 14E is a view showing a result of segmentation carried out with another set of extraction parameters;

FIG. 14F is a view showing feature edges extracted from the boundaries of the segments of FIG. 14E;

FIGS. 15A to 15C show results of feature edge extraction carried out with the apparatus of FIG. 1 on different mesh models prepared from the same solid model, in which an upper part of FIG. 15A is a high-density mesh model prepared with a FEM mesher, an upper part of FIG. 15B is a low-resolution mesh model prepared with a FEM mesher, an upper part of FIG. 15C is a mesh model prepared with STL data conversion, and lower parts of FIGS. 15A to 15C are feature edges obtained by repeating several times the feature edge extraction method of the present invention on the mesh models shown in the upper parts;

FIGS. 16A to 16C are views showing feature edges extracted with the apparatus of FIG. 1 with the use of three sets of extraction parameters;

FIG. 16D is a view showing an aggregation of the feature edges shown in FIGS. 16A to 16C; and

FIG. 17 is a view showing the feature edges of FIG. 16D read into a 3D CAD system.

### DETAILED DESCRIPTION OF EMBODIMENTS

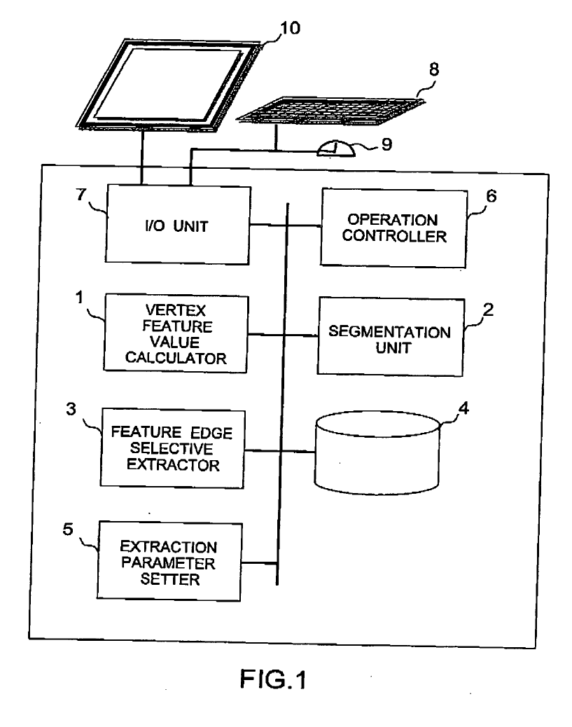

Embodiments of the present invention will be explained in detail with reference to the drawings. FIG. 1 is a view showing functional blocks of an apparatus for extracting feature edges from a 3D or triangular mesh model, according to an embodiment of the present invention. The apparatus may be a computer system installed with software for executing processes to be explained later. In FIG. 1, the functional blocks of the apparatus include a vertex feature value calculator 1, a segmentation unit 2, a feature edge selective extractor 3, a storage unit 4 for storing data, an extraction parameter setter 5, an operation controller 6 for controlling operations and processes, and I/O unit 7 for inputting and outputting data and other signals. The apparatus is connected to peripheral devices including at least a keyboard 8 serving as an input device, a pointing device 9 such as a mouse, and a display 10 for displaying output signals.

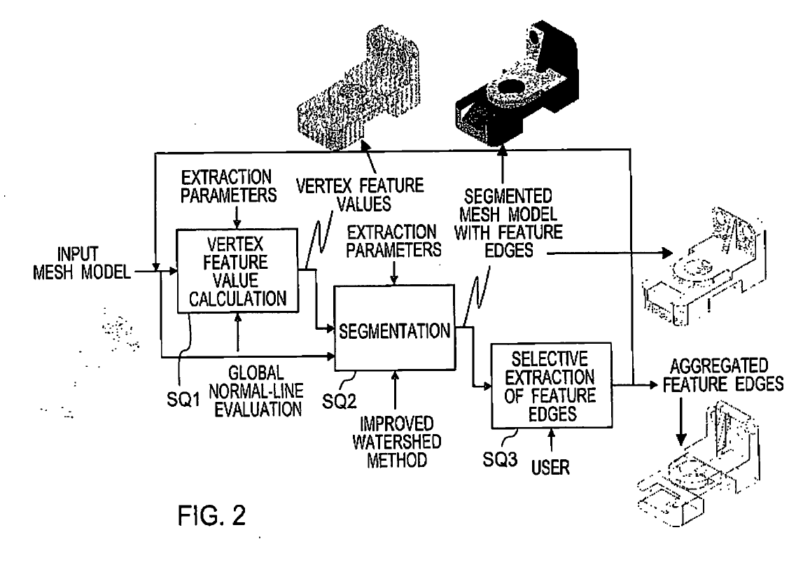

FIG. 2 shows processes carried out with the apparatus of FIG. 1. The processes include vertex feature value calculation SQ1, segmentation SQ2, and feature edge selective extraction SQ3. These processes are carried out in the units 1 to 3 of FIG. 1, respectively.

The vertex feature value calculation SQ1 defines an area based on a Euclidean distance on a 3D or triangular mesh model, globally evaluates normals of a set of triangles in the area, and calculates edge and vertex feature values. The calculated values are used to extract feature edges through discretization and differentiation. The segmentation SQ2 uses the calculated feature values and conducts segmentation. The segmentation SQ2 employs the improved watershed method developed from the watershed method (T. Funkhouser, M. Kazhdan, P. Shilane, P. Min, W. Kiefer, A. Tal, S. Rusinkiewicz, and D. Dobkin, “Modeling by Example,” ACM Transactions on Graphics 23 (3), 609-612, 2004). The improved watershed method is capable of grouping vertexes to define segments each consisting of a set of connected triangles. The boundaries of the segments are extracted as feature edges that satisfy the above-mentioned third requirement. The feature edge selective extraction SQ3 allows a user to interactively select required feature edges from among the feature edges extracted by the segmentation SQ2. The apparatus of FIG. 1 repeats the three processes SQ1 to SQ3 several times with different extraction parameters set by the extraction parameter setter 5. Feature edges extracted with the different parameters are interactively aggregated.

The vertex feature value calculation SQ1 will be explained. This process first calculates edge feature values, and according to the edge feature values, calculates vertex feature values. A simplest way of calculating an edge feature value is calculating a dihedral angle between two planes that share the edge. This technique is effective for sharp dihedral angles but is vulnerable to noise. The technique calculates feature values based on local shapes of a mesh model. The mesh model frequently contains much noise produced when it was prepared by reverse engineering. Accordingly, the feature values calculated with this technique involve the influence of the noise. Due to this, the technique is unable to correctly extract feature edges from edges having small dihedral angles. To solve the problem, the embodiment of the present invention globally evaluates an area defined with a Euclidean distance around an edge and calculates a feature value. FIG. 3 is an explanatory view showing an edge feature value calculation according to the embodiment. Around the middle point of an edge e, a sphere B having a radius r is assumed. Triangles contained in the sphere B have surface normal vectors whose sum is n(bar). The vector sum n(bar) and the edge e define a plane, which divides the sphere B into two hemispheres BR and BL. The hemispheres BR and BL provide surface normal vector sums nBR and nBL weighted by the areas of the respective triangular surfaces as follows:

$$\begin{matrix}{n}_{{B}_{R}} = {\sum }_{f ∈ {F}_{{B}_{R}}} {n}_{f} \vert f ⋂ {B}_{R} \vert & ( 1 ) \\ {n}_{{B}_{L}} = {\sum }_{f ∈ {F}_{{B}_{L}}} {n}_{f} \vert f ⋂ {B}_{L} \vert & ( 2 )\end{matrix}$$

where nf is a unit surface normal vector of a triangular surface f, FBR and FBL are sets of triangles contained in the hemispheres BR and BL, respectively, and |f n BR| and |f n BL| are the areas of portions of the triangular surfaces contained in the hemispheres BR and BL, respectively. There will be a triangle that intersects the sphere or the plane used to divide the sphere into the hemispheres. The area of an in-sphere portion of such a triangle is obtained by replacing the intersecting part with a line segment and by approximating the portion with a polygon. An angle between the surface normal vector sums nBR and nBL is calculated as a feature value ?e(r) of the edge e as follows:

$${θ}_{d} ( r ) = {cos}^{- 1} ( \frac{{n}_{{B}_{R}} \cdot {n}_{{B}_{L}}}{\vert {n}_{{B}_{R}} \vert \vert {n}_{{B}_{L}} \vert} ) \qquad ( 3 )$$

An edge whose edge feature value ?e(r) is greater than a basic feature edge identifying threshold t? is classified as a basic feature edge, and vertexes at each end of the basic feature edge are classified as basic feature vertexes. An edge whose ends are basic feature vertexes is not always a basic feature edge.

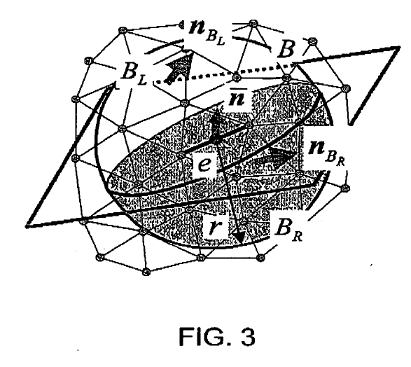

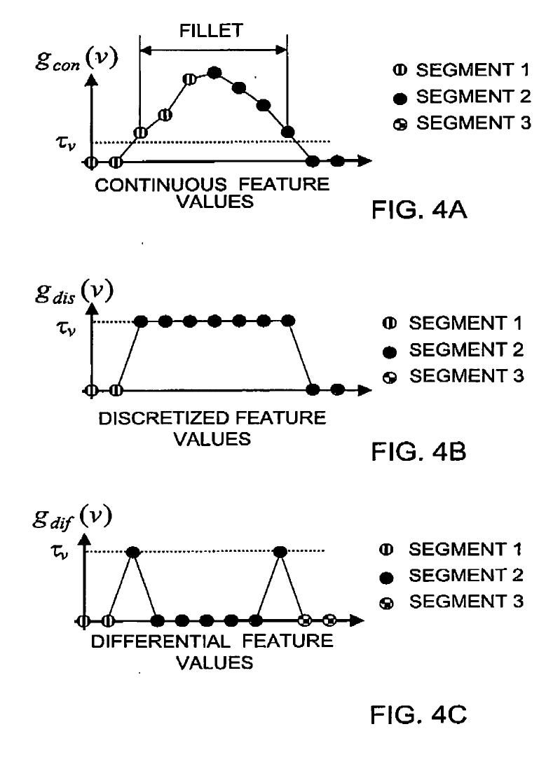

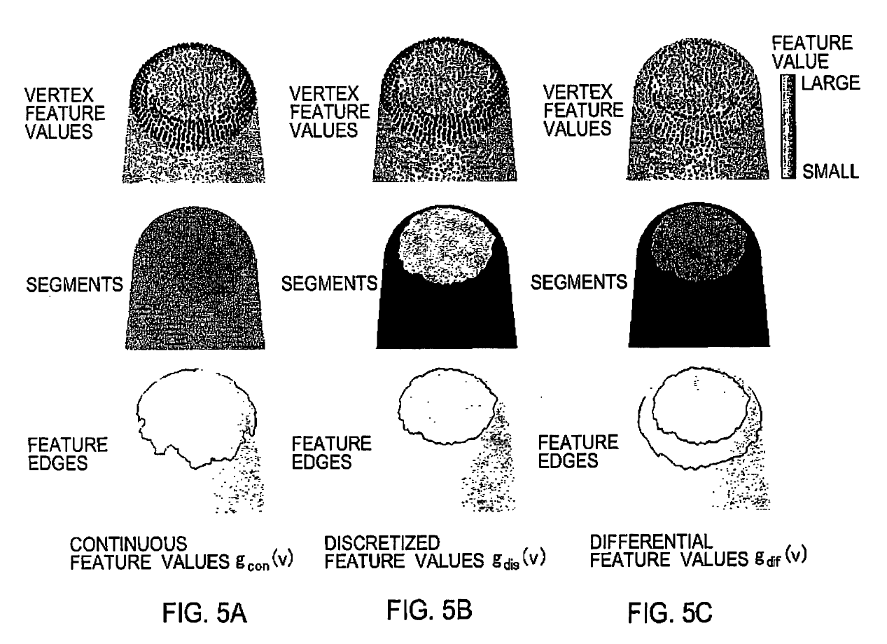

Based on the calculated edge feature value, a vertex feature value is calculated. FIGS. 4A to 4C are graphs showing examples of vertex feature value calculation. FIGS. 5A to 5C show feature edges extracted according to the feature values shown in FIGS. 4A to 4C, respectively. More precisely, FIGS. 4A and 5A relate to continuous feature values. FIGS. 4B and 5B relate to discretized feature values, and FIGS. 4C and 5C relate to differential feature values. A vertex v connects to an edge set en(v). Among edge feature values of this edge set, a largest edge feature value is a continuous feature value gcon(v) for the vertex v.
g_{con}(v)=max_{eεc*(v)}θ_{c}(r) (4)

Continuous feature values provided by the expression (4) vary from one to another when calculated on a fillet surface that must be recognized as a single segment, as shown in FIG. 4A. Namely, the feature value of a vertex at a start point of the fillet surface is small, vertex feature values gradually increase toward the middle point of the fillet surface, and the feature value of a vertex at an end of the fillet surface is small like that of the start point. Based on these feature values, the improved watershed method whose details will be explained later is carried out to provide a segmentation result of FIG. 5A. In FIG. 5A, the fillet surface is divided into two along the center line thereof, and the center line is extracted as a feature edge. The discretization technique of FIG. 4B employs a vertex feature value discretization threshold tv to provide a discretized vertex feature value gdis(v). Discretized vertex feature values calculated for the fillet surface will be constant. With these discretized vertex feature values, the watershed method recognizes the fillet surface as a part of an adjacent area that is smoothly continuous to one side of the fillet surface, as shown in FIG. 5B. Namely, the discretization technique of FIG. 4B is able to extract only one boundary of the fillet surface as a feature edge. The differentiation technique of FIG. 4C calculates a difference between the discretized feature value of the vertex v and that of an adjacent vertex according to the expression (5) mentioned below, to provide a differential feature value gdif(v). This technique can properly extract the boundaries of the fillet surface as shown in FIG. 5C.

$${g}_{dif} ( v ) = \{ \begin{matrix}{g}_{dis} ( v ) - {min}_{{v}^{*} ∈ v} \cdot {g}_{dis} ( {v}^{′} ) , \\ ( {g}_{dis} ( v ) \geq {min}_{{v}^{*} ∈ v} \cdot {g}_{dis} ( {v}^{′} ) ) \\ 0 , otherwise\end{matrix} \qquad ( 5 )$$

where v* is a set of adjacent vertexes of the vertex v. An embodiment of the present invention employs differential feature values only when extracting the boundaries of a fillet surface, and continuous feature values when extracting any other feature edges.

Next, the segmentation SQ2 will be explained. This process employs the improved watershed method. The watershed method has been proposed as an invention related to image segmentation, and at present, is energetically studied in the field of image processing. For example, there is a related document of Andre Bleau and L. Joshua Leon, “Watershed-Based Segmentation and Region Merging,” Computer Vision and Image Understanding 77 (3), 317-370, 2000. Developed from the watershed method is a segmentation technique for a 3D mesh model. The watershed method disclosed in the document of Mangan, et al. mentioned before traces vertexes from one having a higher feature value to another having a smaller feature value like water flowing from a higher place to a lower place. The traced vertexes are provided with segment labels, and vertexes having the same label are grouped into one segment.

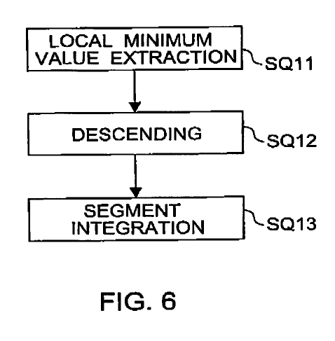

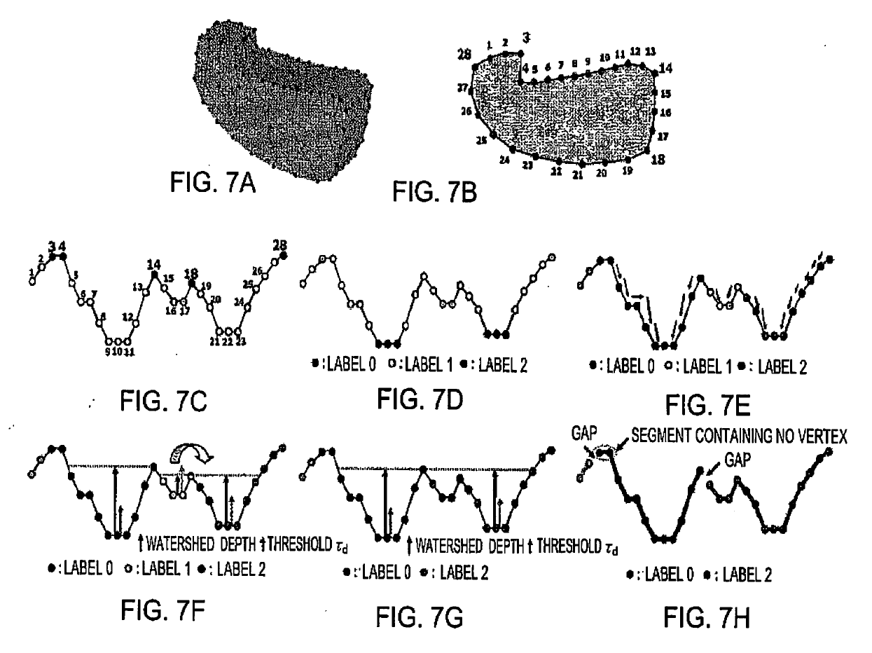

The watershed method involves three steps shown in FIG. 6. FIGS. 7A to 7H roughly explain the watershed method, in which FIG. 7A is a perspective view showing a mesh model to be segmented, FIG. 7B is a sectional view of FIG. 7A, FIG. 7C is a diagram developed from FIG. 7A using the heights thereof as feature values, FIG. 7D shows labels attached to vertexes of the diagram of FIG. 7C, FIG. 7E shows vertexes grouped according to the labels, FIGS. 7F and 7G show a removal of small segments, and FIG. 7H shows a failure of segmentation. In FIG. 7A, a vertex indicated with a black dot has a large feature value and a vertex with a white dot has a small feature value.

In FIG. 6, step SQ11 is a local minimum value extracting process. This process finds, as shown in FIG. 7D, local vertexes each having a local minimum feature value (adjacent feature values being greater than the feature value in question) and provides the vertexes with specific segment labels starting from 0.

Step SQ12 is a descending process. As shown in FIG. 7E, this process brings a vertex having no descending label down to a set of vertexes having a segment label, and assigns this segment label to every vertex passed during the process. Vertexes having the same label are grouped into one segment.

Step SQ13 is a segment integration process. Step SQ12 mentioned above frequently creates small segments each involving a small number of vertexes. The boundaries of such small segments will be extracted as feature edges that are not useful, and therefore, the small-segments must be removed. To achieve this, a difference is calculated, for each segment, between a vertex having a lowest continuous feature value in the segment in question and a vertex “vbou” having a lowest continuous feature value among vertexes that are on the boundaries of the segment in question and adjacent segments. The difference is called a “watershed depth.” Any segment whose number of vertexes is smaller than a minimum vertex number threshold tn and whose watershed depth is smaller than a segment integration threshold td is integrated with the segment that is adjacent to the vertex vbou. This process is repeated until every segment that satisfies the above conditions is removed as shown in FIGS. 7F and 7G.

The watershed method assigns a segment label only to a vertex and forms segments each composed of vertexes. Due to this, the watershed method frequently creates a gap composed of triangles each having three different vertex labels so that the gap belongs to no segment. This results in extracting a feature edge that must be shared as a boundary between adjacent segments but is actually shared by no segments. If there is a region containing no vertex, such as a rectangular region composed of two right triangles, the watershed method is unable to recognize the region as a segment, as shown in FIG. 7H.

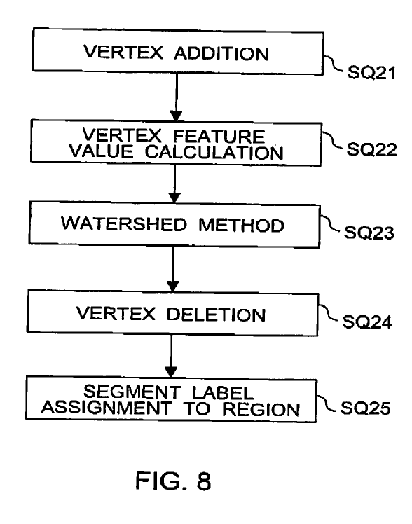

To solve the problems, the improved watershed method was proposed in the document of Razdan et al. mentioned above. To improve a feature edge extraction accuracy, the improved watershed method is based on the watershed method and the technique of assigning segment labels to triangles when dividing a 3D mesh model into segments each composed of triangles. The improved watershed method includes five steps shown in FIG. 8. The five steps are vertex adding step SQ21, vertex feature value calculating step SQ22, watershed step SQ23, vertex deleting step SQ24, and segment label assigning step SQ25.

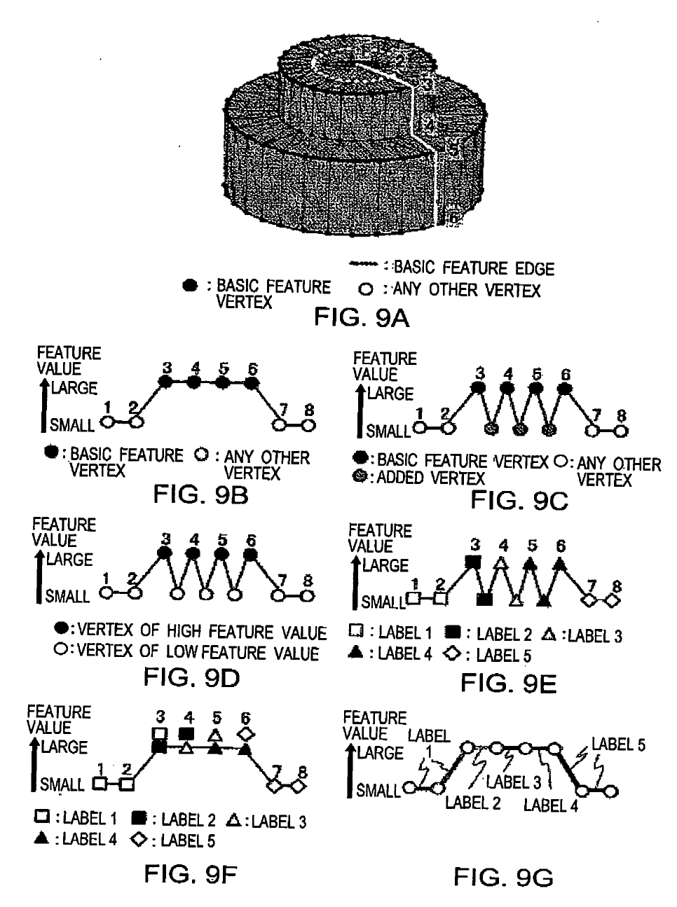

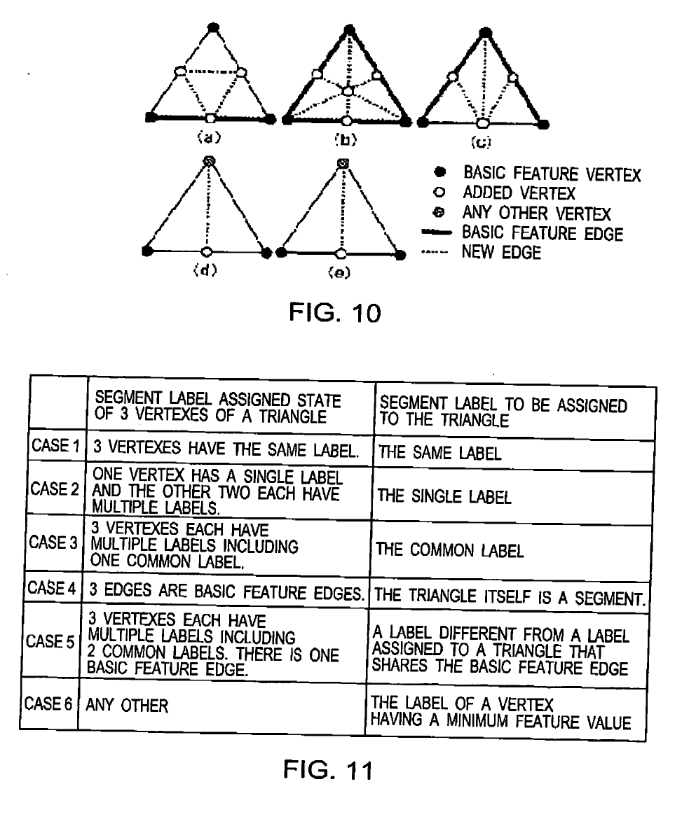

FIG. 9A is a perspective view showing a 3D or triangular mesh model consisting of regions each having to be recognized as a segment but containing no vertex. FIGS. 9B to 9G are diagrams developed from a sectional view of FIG. 9A using the heights thereof as feature values. In each diagram, a line segment represents a triangular mesh. FIG. 10 is an explanatory view showing vertex adding rules.

Step SQ21 of FIG. 8 adds, as shown in FIG. 9C, a vertex to the middle point of each aide of a triangle according to a distribution of basic feature vertexes shown in FIG. 9B and according to the vertex adding rules shown in FIG. 10. This stop is a preparatory step for properly recognizing a region containing no vertex as a single segment.

In FIG. 9D, step SQ22 assigns a maximum one of the vertex feature values to the added vertex that is on a basic feature edge, and a minimum one of the vertex feature values to the added vertex that is on a triangle surface. For any other vertex, step SQ22 assigns the feature value of the edge to which the vertex in question is added.

In FIG. 9E, step SQ23 applies the watershed method to the mesh model to which the vertexes have been added, assigns a segment label to each vertex, and defines segments each consisting of a set of vertexes.

In FIG. 9F, step SQ24 provides each basic feature vertex with the segment label of an adjacent vertex in addition to the segment label of its own, and then, deletes the vertexes added in step SQ21. As a result, each basic feature vertex has a plurality of segment labels.

In FIG. 9G, step SQ25 assigns a segment label to each triangle according to the segment labels assigned to the vertexes of the triangle. At this time, step SQ25 refers to the table of FIG. 11. Cases 2 to 5 shown in the table of FIG. 11 are particularly effective when segmenting a mesh model including a region that must be recognized as a single segment but contains no vertex. On the other hand, case 6 shown in FIG. 11 is effective for properly assigning a segment label to each triangle that is in a gap to be created when the watershed method is applied to a high-density mesh model obtained by reverse engineering. In this way, every triangle is provided with a segment label and triangles having the same segment label are integrated into one.

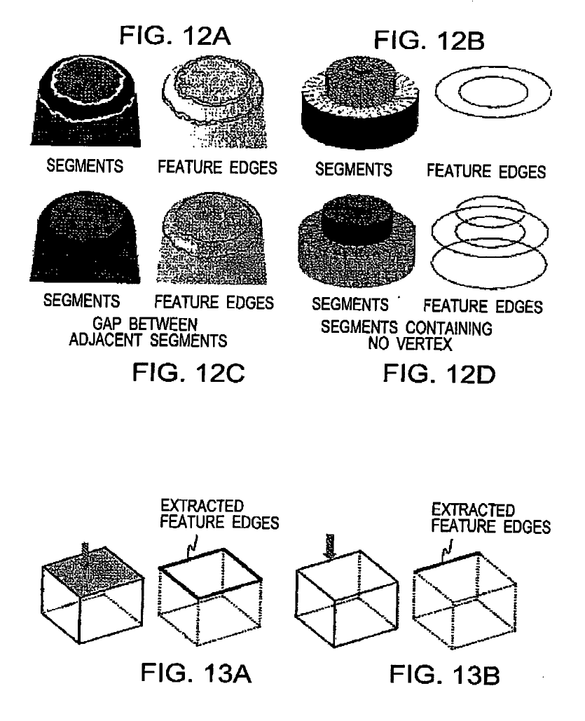

With steps SQ21 to SQ25, the mesh model is divided into segments each composed of connected triangles, and the boundaries of each segment are extracted as feature edges. FIGS. 12A to 12D show results of segmentation by the conventional watershed method and improved watershed method, in which FIGS. 12A and 12B are of the conventional watershed method and FIGS. 12C and 12D are of the improved watershed method. In FIG. 12A, the conventional watershed method produces a gap between adjacent segments, and accordingly, a boundary that must be shared as a feature edge between adjacent segments is not actually shared between them. In FIG. 12B, segmentation by the conventional watershed method is unsatisfactory. This is because each region of the mesh model that must be recognized as a segment contains no vertex. These problems are solved by the improved watershed method. In FIG. 12C, the improved watershed method provides a feature edge shared between adjacent segments. In FIG. 12D, segmentation by the improved watershed method is satisfactory.

Next, the effect on feature edge extraction of five extraction parameters used by a feature edge extracting method according to an embodiment of the present invention will be explained. The extraction parameters are set by the extraction parameter setter 5. The radius r of a sphere is used to determine an evaluation range when calculating edge feature values. If the radius r is small, the evaluation range will be limited to easily extract sharp feature edges. If the radius r is large, the evaluation range will be expanded to easily extract feature edges at a part whose shape gently changes.

The vertex feature value discretization threshold tv is used when adjusting positions to extract the boundaries of a fillet surface. The threshold tv must be properly set to match with the feature value of a vertex that is on a boundary of a fillet surface. If the threshold tv is smaller than a proper value, boundaries to be extracted will define a fillet surface that is larger than an actual fillet surface. If the threshold tv is larger than a proper value, boundaries to be extracted will define a fillet surface that is smaller than an actual fillet surface.

The basic feature edge identifying threshold t? is mainly used to extract a crease edge. If the threshold t? is large, only the boundaries of a surface having a large dihedral angle will be extracted. If the threshold t? is small, not only the boundaries of a surface having a large dihedral angle but also the boundaries of a surface having a small dihedral angle will be extracted.

If the minimum vertex number threshold tn is small, each segment to be separated contains a small number of vertexes, and the boundaries of such a segment are extracted. If the threshold tn is large, each segment to be separated contains a large number of vertexes, and the boundaries of such a segment are extracted.

If the segment integration threshold td is small, each segment to be formed involves a small vertex feature value difference, and the boundaries of such a segment are extracted. If the threshold td is large, each segment to be formed involves a large vertex feature value difference, and the boundaries of such a segment are extracted.

The process SQ1 of determining basic feature edges and basic feature vertexes is insufficient to completely extract required feature edges if it is carried out only once with a single set of parameters. Namely, the technique of the present invention must repeatedly be carried out with different sets of extraction parameters, to allow a user to interactively select, on a display, required edges from among feature edges extracted with the different extraction parameter sets. The edges selected by the user are then aggregated.

The apparatus according to the embodiment of the present invention is provided with two feature edge selecting methods that allow a user to efficiently select feature edges. FIG. 13A shows the first feature edge selecting method that extracts, when a user specifies a region in a segment, all feature edges that form a loop along the boundary of the segment. FIG. 13B shows the second feature edge selecting method that extracts, when a user specifies a mesh edge corresponding to a feature edge, a partial feature edge that is defined by vertexes at each of which at least three feature edges intersect. These two methods may be properly employed to selectively aggregate user required feature edges.

The embodiment mentioned above is capable of automatically creating a solid model from a mesh model by extracting feature edges from the mesh model according to the global normal-line evaluation technique and improved watershed method.

### EXAMPLES

Tests were carried out and test results confirmed that the present invention is capable of extracting feature edges from a mesh model without the influence of noise contained in the mesh model or a method used to form the mesh model, extracting the boundaries of a fillet surface as feature edges, recognizing, as a segment, an area surrounded with feature edges that form a loop, and selectively extracting feature edges depending on an object of use. The extracted feature edges are readable into a 3D CAD system.

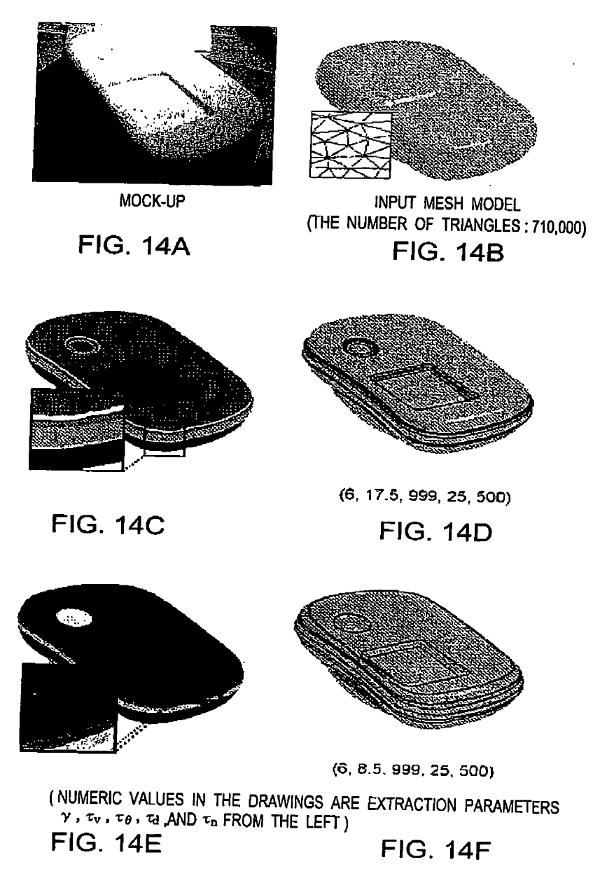

FIGS. 14A to 14F show results of tests carried out to verify the effect of the present invention. FIG. 14A shows a mock-up of an IT hardware casing made of hard urethane foam. The mock-up was measured with a noncontact measuring device (Comet 400 (trade name)) to define surface points (about 1.4 million points). Based on the surface points, a high-density mesh model composed of triangular meshes was prepared. From the mesh model, feature edges were extracted as shown in FIGS. 14C to 14F. FIGS. 14C and 14E show results of segmentation carried out with different extraction parameter sets. FIGS. 14D and 14F show results of extraction of the boundaries of segments shown in FIGS. 14C and 14E as feature edges, respectively. As is apparent from the test results, the present invention can correctly extract feature edges even from a mesh model involving much measurement noise if extraction parameters are properly set. In each test, a processing time spent for automatically extracting feature edges with one set of extraction parameters using a personal computer equipped with a 2.4-GHz Xeon and a 2-GB memory was about six minutes (five minutes for calculating vertex feature values and one minute for extracting feature edges from segments).

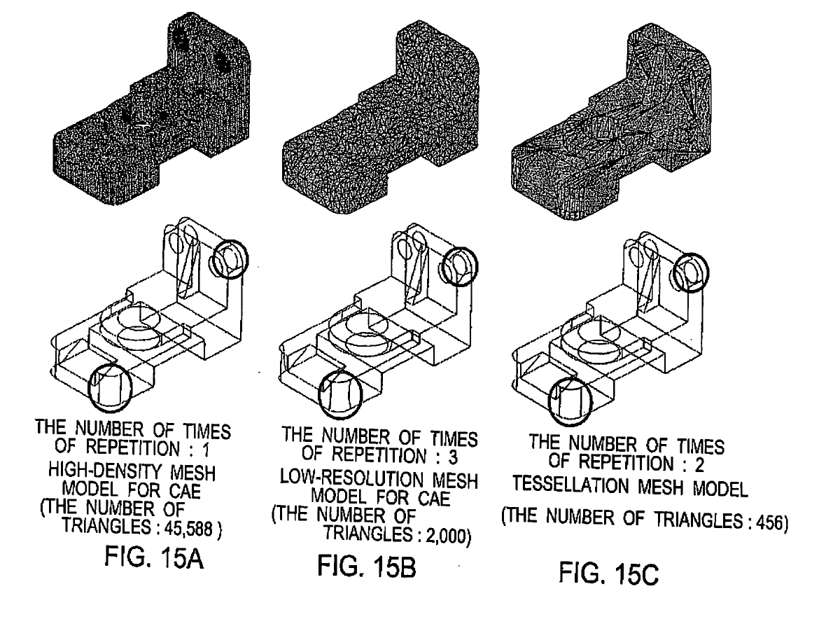

FIGS. 15A to 15C show mesh models created from a solid model using different mesh model forming techniques, as well as feature edges extracted from the mesh models. An upper part of FIG. 15A shows a high-density mesh model created with a PEM mesher, an upper part of FIG. 15B a low-resolution mesh model created with a FEM mesher, and an upper part of FIG. 15C a mesh model created with STL data conversion. Lower parts of FIGS. 15A to 15C show featured edges extracted from the mesh models after repeatedly carrying out the feature edge extraction method of the present invention. It is apparent from FIGS. 15A to 15C that the present invention can substantially always extract identical feature edges from different mesh models. In FIGS. 15A and 15B, an edge of a mesh is not always on an edge of the solid model. Accordingly, an edge extracted as a feature edge is an edge that is considered to be nearest to an actual edge of the original solid model. Due to this, slight errors are observed in the feature edges shown in FIGS. 15A and 15B.

The sphere radius r, which is one of the extraction parameters, may not be strictly set. For a mesh model created by measuring a physical model and containing much noise, the sphere radius r may be one fiftieth to one hundredth of the diagonal of a bounding box of the input mesh model, to provide a good result. For a mesh model involving many crease edges each with a large dihedral angle, the sphere radius r may be smaller to provide a good result. As shown in the examples of FIGS. 14A to 14F, the vertex feature value discretization threshold tv may be changed to correctly extract the boundaries of a fillet surface having a small or large diameter.

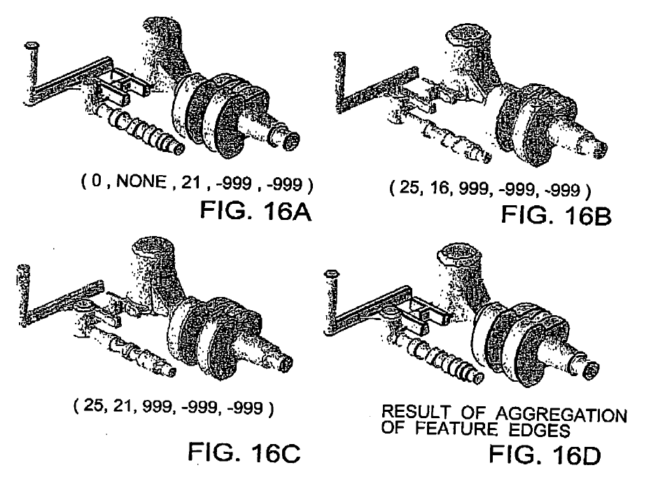

FIGS. 16A to 16D show feature edges selected by a user and an aggregation of the selected feature edges. The feature edges were extracted from a mesh model prepared by a FEM mesher and composed of about 65,000 small triangles involving little distortion. In FIGS. 16A to 16D, a thin line represents a feature edge extracted with a set of extraction parameters, and a thick line a feature edge selected by the user. FIGS. 16A to 16C show feature edges extracted with three different sets of extraction parameters, respectively, and FIG. 16D shows an aggregation of the feature edges selected by the user. In this way, feature edges extracted with different sets of extraction parameters can be aggregated into a set of feature edges. A processing time spent for automatically extracting feature edges with a set of extraction parameters was about 4 to 26 seconds.

It is apparent from FIGS. 14 to 16 that the present invention can extract feature edges that loop, as well as the boundaries of a fillet surface as feature edges.

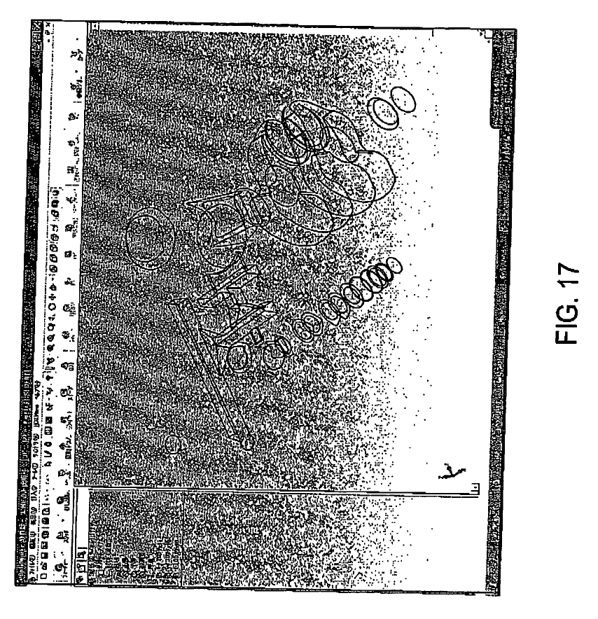

FIG. 17 shows the feature edges shown in FIGS. 16A to 16D read into a 3D CAD system (SolidWorks (trade name)). It is apparent from FIG. 17 that feature edges extracted and aggregated according to the present invention are correctly readable into a 3D CAD system.

What is claimed is:

1. An apparatus for extracting feature edges from a triangular mesh model, comprising;
a storage unit configured to store data;
a vertex feature value calculator configured to retrieve data related to the mesh model from the storage unit, globally evaluate normals of triangles in each region that is defined on the mesh model by a Euclidean distance, calculate edge and vertex feature values based on a result of the evaluation, carry out discretization and differentiation on the calculated vertex feature values, and extract feature edges;
a segmentation unit configured to separate the mesh model into segments each composed of a set of connected triangles according to the calculated feature values and an improved watershed method capable of grouping vertexes and extract boundaries of the segments as feature edges; and
a feature edge selective extractor configured to allow a user to interactively select required feature edges from among the extracted feature edges and output data related to the selected feature edges.

2. A program for extracting feature edges from a triangular mesh model, the program instructing a computer to execute the steps of:
retrieving data related to the mesh model from an input unit or a storage unit;
globally evaluating normals of triangles in each region that is defined on the mesh model by a Euclidean distance and calculating edge and vertex feature values according to a result of the evaluation;
carrying out discretization and differentiation on the calculated vertex feature values and extracting feature edges;
separating the mesh model into segments each composed of a set of connected triangles according to the calculated vertex feature values and an improved watershed method capable of grouping vertexes, and extracting boundaries of the segments as feature edges; and
allowing a user to interactively select required feature edges from among the extracted feature edges and outputting data related to the selected feature edges.

3. The program of claim 2, wherein the program further instructs the computer to execute the steps of:
setting extraction parameters and the number of times of repetition; and
repeating the steps with the use of the set extraction parameters for the set number of times of repetition.

4. A method of extracting feature edges from a triangular mesh model, comprising the steps of:
retrieving data related to the mesh model from an input unit or a storage unit;
globally evaluating normals of triangles in each region that is defined on the mesh model by a Euclidean distance and calculating edge and vertex feature values according to a result of the evaluation;
carrying out discretization and differentiation on the calculated vertex feature values and extracting feature edges;
separating the mesh model into segments each composed of a set of connected triangles according to the calculated vertex feature values and an improved watershed method capable of grouping vertexes, and extracting boundaries of the segments as feature edges: and
allowing a user to interactively select required feature edges from among the extracted feature edges and outputting data related to the selected feature edges.

5. The method of claim 4 further comprising the steps of:
setting extraction parameters and the number of times of repetition; and
repeating the steps with the use of the set extraction parameters for the set number of times of repetition.
